(19) United States
(12) Patent Application Publication
(10) Pub. No.: US 2026/0166804 A1
(43) Pub. Date: Jun. 18, 2026

(54) Tool For Manufacturing A Thermoformed Fiber Composite Component

(71) Applicant: Premium Aerotec GmbH, Augsburg (DE)

(72) Inventors: Thomas Geipel, Augsburg (DE); Chris Rennecke, Augsburg (DE); Alexander Dragun, Augsburg (DE); Jan Reinfrank, Augsburg (DE); Werner Thiergärtner, Augsburg (DE)

(73) Assignee: Premium Aerotec GmbH, Augsburg (DE)

(21) Appl. No.: 19/498,928

(22) PCT Filed: Mar. 13, 2024
(86) PCT No.: PCT/EP2024/056745

§ 371 Date: Jan. 2, 2026

(30) Foreign Application Priority Data
Mar. 14, 2023 (DE) 10 2023 106 384.7

(51) Int. Cl. B29C 51/36; B29C 51/10; B29C 51/14; B29K 105/08

(52) U.S. Cl. CPC B29C 51/36; B29C 51/10; B29C 51/145; B29K 2105/089

(57) ABSTRACT

A mould for producing a hot-formed fibre composite component, has a forming tub with a base, a peripheral edge and a tub opening facing away from the base and delimited by the edge, a forming mould, arranged in the forming tub, for applying a preform, and clamping frame supporting an elastic membrane and having a lower boundary surface for application on an upper boundary surface of the edge. The edge and the clamping frame are designed to establish a fluid-tight connection with each other, so that the forming tub with the applied clamping frame can be evacuated by suction of air through a suction connection. The membrane is designed to cling to a preform located in the forming tub and adjacent, free base regions during evacuation, so that the preform is pressed onto the forming mould. The mould is heat-resistant up to a curing temperature of at least 200° C.

### TECHNICAL FIELD

The present description relates to a tool for manufacturing a thermoformed fiber composite component and a method for manufacturing a thermoformed fiber composite component.

### TECHNICAL BACKGROUND

In manufacturing of aircraft structures, plane components are often combined with stiffening elements that have a highly curved profile. If the structure in question is made of a fiber composite material, such as CFRP, various manufacturing processes can be used to produce the stiffening elements.

A known method is known as hot forming, in which a preform with a fiber layer structure in an uncured matrix is mechanically formed at a suitable forming temperature, and the formed preform is then cured in an autoclave. Removing the formed preform from a forming tool and inserting it into a curing tool is a complex process, as damage and positioning deviations must be avoided. The manufacturing of a tool system with a placing tool, a forming tool, and a curing tool also results in high costs.

### Description

As an object, it can be considered to propose an alternative tool system that is more cost-effective and requires less manual effort.

This object is solved by the subject matter of independent claim 1. Further embodiments are set out in the dependent claims and in the following description.

A tool for manufacturing a thermoformed fiber composite component is proposed, comprising a forming trough with a bottom, a circumferential edge and a trough opening facing away from the bottom, which is bounded by the edge, a forming tool arranged in the forming trough for placing a preform, and an elastic membrane supporting stenter frame with a lower boundary surface for placing on an upper boundary surface of the edge, wherein the edge and the stenter frame are configured to form a fluid-tight connection with each other so that the forming trough with the stenter frame placed on it is evacuable by air extraction through a suction connection arranged in the forming trough, wherein the membrane is configured to conform to a preform located in the forming trough and adjacent free bottom areas in the direction of the bottom of the forming trough when the forming trough is evacuated, so that the preform is pressed onto the forming tool, and wherein the tool is temperature-resistant up to a curing temperature of at least 200° C.

The forming trough has a bottom that preferably comprises a flat inner bottom surface. The bottom is surrounded by the circumferential edge, wherein the edge preferably runs perpendicular to the inner bottom surface and completely surrounds the bottom. It may be advantageous to design the forming trough as a single, integral component. This could be achieved by casting and subsequent surface treatment; by machining; or by additive manufacturing processes. However, it is also conceivable to manufacture the bottom separately from the edge and then connect the two components together in a form-fitting or force-fitting manner. When manufacturing the forming trough, a fluid-tight connection between the bottom and the edge is required. The forming trough could be made of a metallic material, ceramic, or other materials that are sufficiently temperature-resistant.

The edge has an upper boundary surface which could, for example, be parallel to the bottom. The upper boundary surface serves to place the stenter frame so that it completely covers the trough opening. As described below, at least one seal may be arranged on the upper boundary surface, or the upper boundary surface may be configured to form a fluid-tight connection with a seal arranged on the stenter frame.

The stenter frame has a shape that is adapted to the shape of the edge. The stenter frame preferably has a lower boundary surface that can be placed flush on the upper boundary surface of the edge. The stenter frame could have a circumferential profile component whose profile cross-section has a width that is adapted to the material thickness of the edge. The profile component thus encloses a membrane opening that corresponds to the trough opening. This membrane opening is completely spanned by the elastic membrane.

The elastic membrane could comprise silicone or be based on a silicone-like material or another suitable elastomer. The elastic membrane has an elongation at break of preferably at least 200%, so that the membrane is sufficiently movable during evacuation, as described below. It is preferable to select a material for the membrane that returns as far as possible to its original unstretched state.

The forming trough may comprise the suction connection at the edge, in particular a lower region of the edge, or at a region of the bottom close to the edge, which suction connection is connectable to an air extraction device. This allows an air extraction from the cavity between the forming trough and the stenter frame with the membrane arranged thereon, so that the membrane moves toward the bottom due to the negative pressure.

The forming tool is arranged on the bottom and has a predetermined shape which determines the forming of a preform from a fiber composite material. The forming tool could, for example, be placed centrally on the bottom and protrude from the bottom towards the trough opening. The preform is placed on a support surface of the forming tool that faces away from the bottom and toward the trough opening. When the cavity is evacuated, the elastic membrane moves continuously toward the bottom and thus toward the preform arranged on the forming tool. This causes the membrane to exert increasing pressure on the preform, which is thereby pressed against the forming tool.

If the tool according to the invention is located in an oven, an autoclave, or similar, or if it is heated by an integrated or external heating device, the tool can reach a predetermined forming temperature. Once this temperature is reached, evacuating the cavity of the forming trough causes the preform to be pressed onto the forming tool by the pressure of the elastic membrane, thereby assuming the shape specified by the forming tool. Once the cavity has been evacuated as far as possible, the membrane lies flush against a surface of the preform facing the membrane. In this state, the preform can be held for subsequent curing.

The curing could be carried out in the same oven or autoclave, which is then heated to a predetermined curing temperature. In addition, increased pressure can also be applied to the tool during curing, for example in a typical pressure range of up to 8 bar. The tool according to the invention is suitable for tolerating the curing temperature through the use of suitable materials, for example metallic materials and a silicone-containing membrane. Consequently, the tool according to the invention allows at least the forming tool and the curing tool to be combined with each other in order to significantly reduce the costs for the necessary tools and at the same time to avoid a very position-accurate placement due to the absence of the step of removing from a forming tool and inserting into a curing tool.

In an advantageous embodiment, the edge is higher than the common height of the forming tool and a provided preform. A buckling of the preform due to mechanical stress generated by the membrane immediately after the tool is closed can be avoided. Furthermore, it is also possible to manufacture profiles in a double-curved shape or with an omega geometry. The membrane can thus first be placed gently and evenly on the preform and then continuously press the preform onto the surface of the forming tool facing the membrane.

In an advantageous embodiment, the tool further comprises at least one circumferential seal arranged on the upper boundary surface and/or the lower boundary surface, wherein the circumferential seal is configured to seal the upper boundary surface and the lower boundary surface against each other to be fluid-tight. The circumferential seal could preferably be configured as a single piece or as a ring respectively, so that there are no free ends of the seal that enclose a gap between them and lead to leakage. It may be advisable to use two or more seals that run around each other so that reliability is improved and pressure resistance is increased. The seals serve to create an isolated atmosphere under the membrane. The seals could be made from the same or a similar material as the membrane. Temperature-resistant, permanently elastic polymers, natural or synthetic rubbers, and the like may also be particularly suitable.

In an advantageous embodiment, the suction connection is arranged in the base or on a base section of the edge facing the base. When arranged on the base, the forming tool can be easily replaced, as it can rest on the base surface and be directly coupled to the suction connection. As explained further below, the forming tool may have a base that can be placed on the bottom and extends there to the edge. A form-fitting or force-fitting connection with the suction connection could be made directly. Suction channels could be connected to the suction connection on the bottom, leading to several suction openings distributed across the bottom. The suction channels could also be arranged in the forming tool. The overall suction is improved by the adapted arrangement of suction openings. If the suction connection is arranged at the edge, air can be sucked out of the cavity at the edge, wherein the edge can also have suction channels that can lead to several suction openings arranged at the edge.

In an advantageous embodiment, the suction connection is in fluid connection with several suction openings arranged in the bottom or in the forming tool. The suction openings could be distributed over a large area across the bottom or the forming tool, so that even different intended shapes of the forming tool lead to reliable suction of the air from the cavity. If, for example, the membrane is placed on some of the suction openings during the evacuation process, these are closed by the membrane. However, other suction openings could remain free and allow a continued suction.

In an advantageous embodiment, the forming tool is detachably insertable into the forming trough. The tool can therefore be used in a modular manner for the manufacturing of a wide variety of profiles.

In an advantageous embodiment, the forming tool has a base body that can be placed on the bottom, guided at the edge and/or by guide elements. The bottom and the forming tool could preferably be adapted to each other in their dimensions in such a way that the forming tool completely fills the bottom after being inserted into the forming trough and is thus firmly positioned on the tool. The edge or separate guide means could be used to guide the forming tool, for example positioning pins or positioning holes in the bottom, grooves or springs on the edge, or similar. It is also conceivable that the suction connection, if arranged in the bottom, could protrude into an opening of the forming tool and be used to guide and fix the forming tool in place. Suction openings could be provided in the base body and connected to the suction opening. For this purpose, the base body could have suction channels extending from the suction opening to the suction openings. The position and number of suction openings could be adapted to the respective forming tool.

In an advantageous embodiment, the tool further comprises a lower separating film and an upper separating film that is overlappable with the lower separating film for enclosing a preform to simplify the placing of the preform on the forming tool and to prevent contamination. The lower separating film could have an area that is slightly smaller than the area of the bottom but larger than the size of the preform. The preform could be arranged on the lower separating film and then covered with the upper separating film. In particular, if the lower separating film is slightly larger, it could be gripped at the edges to move the preform. Overall, the preform can be prevented from becoming contaminated when it is moved onto the forming tool and the positionability can be improved.

In an advantageous embodiment, the tool further comprises a placing tool with a placing area for depositing the preform, wherein the placing area is smaller than the surface area of the bottom. The placing tool could have an area that corresponds approximately to the area of the bottom. The placing area located thereon could be provided as a receptacle for the lower separating film on which the layer structure of the preform is created. It is conceivable to pre-harden the preform somewhat, wherein the placing tool could be placed in the forming trough for this purpose. However, this is not necessary within the scope of the invention. The invention also relates to a method for manufacturing a thermoformed fiber composite component, comprising the steps of providing a preform; placing the preform on a forming tool arranged on a bottom of a forming trough, which comprises a circumferential edge and a trough opening facing away from the bottom, which is bounded by the edge; resting a lower boundary surface of a stenter frame supporting an elastic membrane on an upper boundary surface of the edge, wherein the edge and the stenter frame are configured to form a fluid-tight connection with each other; heating the assembly to a forming temperature; air extraction through a suction connection arranged in the forming trough so that the membrane, in the direction of the bottom of the forming trough, nestles against the preform and adjacent free bottom areas, so that the preform is pressed onto the forming tool and deforms in the process; heating the assembly to a curing temperature and curing the formed preform to manufacture the component; and removing the stenter frame with the membrane and removing the component.

In an advantageous embodiment, providing the preform comprises placing the preform on a placing tool and/or cutting a prepreg to size.

In an advantageous embodiment, the preform is arranged on a lower separating film and covered by an upper separating film before being placed on the forming tool.

In an advantageous embodiment, before curing the formed preform, the assembly is arranged in an atmosphere with increased pressure in a conventional pressure range up to 8 bar.

### BRIEF DESCRIPTION OF THE FIGURES

The following describes the embodiments in more detail with reference to the accompanying drawings. The illustrations are schematic and not to scale. Identical reference numerals refer to identical or similar elements. They show:

FIG. 1 a schematic view of a placing tool.

FIG. 2 a schematic view of a forming trough with a forming tool and a preform, which is being placed on the forming tool.

FIG. 3 the forming trough with a stenter frame having an elastic membrane, the stenter frame being arranged on the forming trough.

FIG. 4a process of forming the preform by the membrane through air extraction.

FIG. 5 a process of removing the stenter frame and the membrane in order to remove a cured component.

### DETAILED DESCRIPTION OF EMBODIMENTS

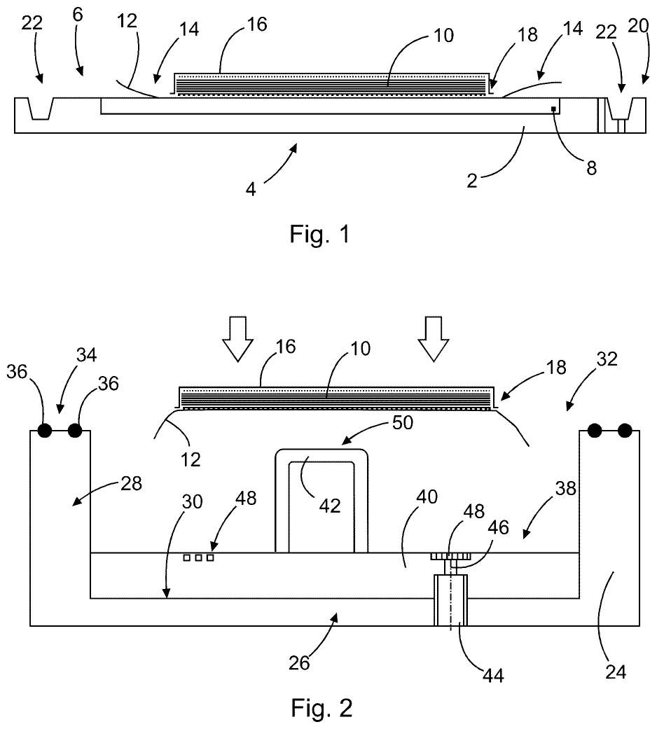

FIG. 1 shows a placing tool 2 with an lower side 4 and an upper side 6, wherein a placing area 8 is arranged on the upper side 6. A preform 10 can be manufactured there, for example by cutting a prepreg, by laying pre-impregnated fiber fabrics or fiber mats or the like on top of each other. A lower separating film 12 is arranged on the placing area 8, for example, onto which the preform 10 is placed in order to prevent it from sticking to the placing area 8 and to prevent contamination of the preform 10, as well as to improve transportability.

The lower separating film 12 has an area that significantly exceeds the base area of the preform 10 and consequently comprises a circumferential edge strip 14 that can be gripped. This could be done, for example, with suction cups of a lifting device. The preform 10 is covered, for example, by an upper separating film 16, which provides an overlap 18 with the lower separating film 12. This completely encloses the preform 10.

On outer edges 20 of the placing tool 2, recesses 22 are arranged for example, which can form a positive connection with a fixing frame (not shown) or the like in order to fix the placing tool 2.

The preform 10, which could also be supplied ready-made by a supplier in the form shown, is to be formed for manufacturing a curved profile component. For example, the preform 10 can be used for manufacturing a stringer or similar element for an aircraft structure. For this purpose, a forming trough 24 is shown in FIG. 2 comprising a bottom 26 and a circumferential edge 28 surrounding the bottom 26. The bottom 26 has a bottom surface 30, which is exemplarily completely flat and extends to the edge 28. The edge 28 runs perpendicular to the bottom surface 30 and has a trough opening 32 facing away from the bottom 26. An upper boundary surface 34 of the edge 28, which runs parallel to the base surface 30, has two circumferential seals 36, which are, for example, annular in shape and each run without gaps on the upper boundary surface 34.

A forming tool 38 is arranged on the bottom 26, which comprises a base 40 and a forming body 42. The base 40 extends essentially over the entire bottom surface 30 and runs to the edge 28. A suction connection 44 is provided on the bottom 26, which suction connection, for example, extends vertically through the bottom 26 into the base 40 and is in fluid connection with a suction channel 46 therein. The suction channel 46 is in fluid connection with several suction openings 48 distributed over the base 40. The suction connection 44 can be coupled to an external suction device (not shown here) which places a vacuum on the suction connection 44 and conveys air through it into the suction device. In this illustration, the preform 10 is also shown with the separating films 12 and 16 as it is placed on a support surface 50 of the forming body 42.

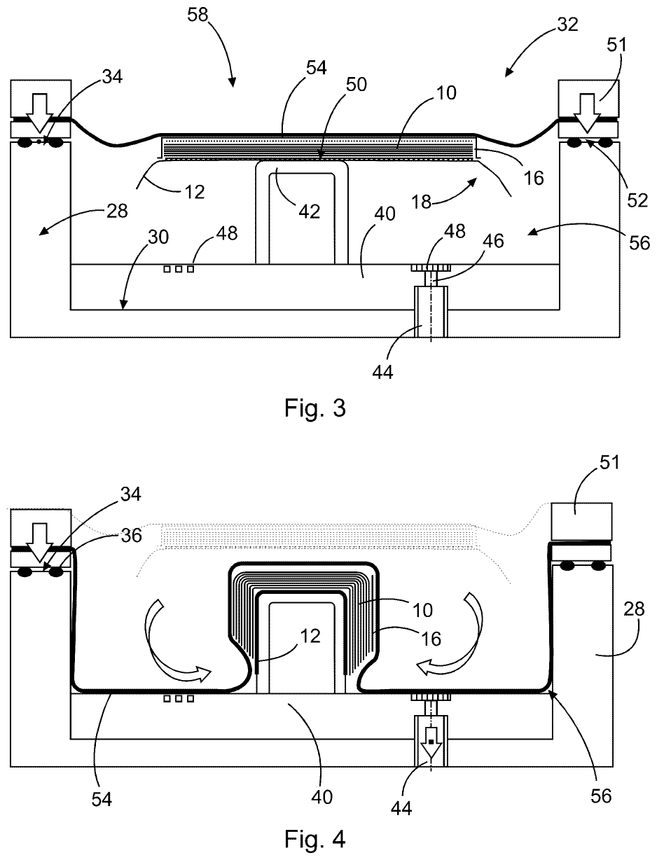

FIG. 3 further shows a stenter frame 51, which has a lower boundary surface 52 that largely corresponds to the upper boundary surface 34 of the forming trough 24. It should be noted at this point that the forming trough 24 may have a square, rectangular, or round, in particular circular, cross-section, for example, and that the circumferential edge 28 and the stenter frame 51 are shaped corresponding therewith.

An elastic membrane 54 is further shown, which is supported by the stenter frame 51 and extends completely over the trough opening 32. The stenter frame 51 can be placed on the upper boundary surface 54 in such a way that the seals 36 create a fluid-tight connection between the stenter frame 51 and the edge 28, thereby sealing a cavity 56 in the tool 58 formed by the elements shown from the surrounding atmosphere.

Before the actual forming process, the tool 58 is heated to a forming temperature and the components forming the tool 58 are configured to be temperature-resistant accordingly. The forming temperature could, for example, be in the range of 80° C. to 120° C. Heating can be carried out in a furnace or autoclave not shown here, or by heating elements integrated into the tool 58 or external heating elements.

FIG. 4 shows an evacuation of the cavity 56 by air extraction via the suction connection 44. This causes the membrane 54 to be placed on the preform 10 and to press it onto the forming tool 40. This forms the preform 10 in such a way that it takes on the shape of the forming tool 42. Curing can then take place in this state. The curing is carried out by heating the tool 58 to a curing temperature, which could be in the range of 150° C. to 200° C., for example. During the curing process, the preform 10 is additionally mechanically fixed by placing the tool 58 in an atmosphere with a pressure of up to 8 bar.

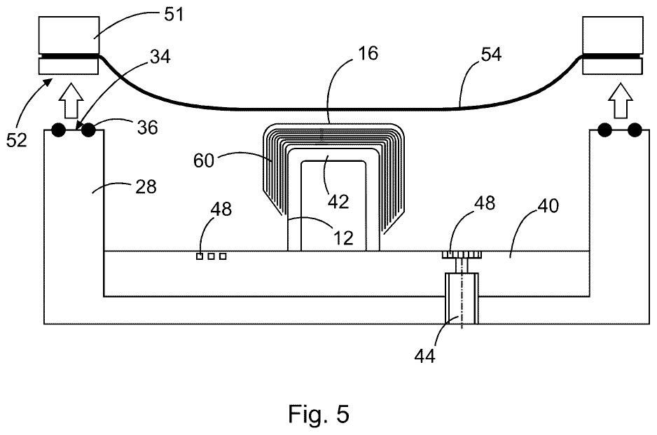

Then, as shown in FIG. 5, the stenter frame 51 together with the membrane 54 is removed from the edge 28 and the manufactured component 60 can be removed from the tool 58. The separating films 12 and 16, which are still on the component 60, allow the component 60 to be easily detached from the forming body 42.

It should also be noted that “comprising” or “having” does not exclude other elements or steps, and “one” or “a” does not exclude a plurality. It should also be noted that features or steps described with reference to one of the above embodiments may also be used in combination with other features or steps of other embodiments described above. Reference signs in the claims are not to be regarded as limitations.

### LIST OF REFERENCE SIGNS

2 placing tool
4 lower side
6 upper side
8 placing area
10 preform
12 lower separating film
14 circumferential edge strip
16 upper separating film
18 overlap
20 outer edge
22 recess
24 forming trough
26 bottom
28 edge
30 bottom area
32 trough opening
34 upper boundary surface
36 seal
38 forming tool
40 base
42 forming body
44 suction connection
46 suction channel
48 suction opening
50 support surface
51 stenter frame
52 lower boundary surface
54 membrane
56 cavity
58 tool
60 component

1. A tool for manufacturing a thermoformed fiber composite component, the tool comprising:
a forming trough with a bottom, a circumferential edge, and a trough opening facing away from the bottom and bounded by the circumferential edge;
a forming tool arranged in the forming trough for placing a preform thereon; and
a stenter frame, supporting an elastic membrane, with a lower boundary surface for placing on an upper boundary surface of the circumferential edge;
wherein the circumferential edge and the stenter frame are configured to form a fluid-tight connection with each other, so that the forming trough with the stenter frame placed thereon is evacuable by air extraction through a suction connection arranged in the forming trough;
wherein the elastic membrane is configured to nestle, in the direction of the bottom of the forming trough, against the preform located in the forming trough and adjacent free bottom areas during evacuating the forming trough, so that the preform is pressed onto the forming tool; and
wherein the tool is temperature-resistant up to a curing temperature of at least 200° C.

2. The tool according to claim 1,
wherein the circumferential edge is higher than a common height of the forming tool and the provided preform.

3. The tool according to claim 1,
further comprising at least one circumferential seal arranged on at least one of the upper boundary surface or the lower boundary surface;
wherein the circumferential seal is configured to seal the upper boundary surface and the lower boundary surface against each other to be fluid-tight.

4. The tool according to claim 1,
wherein the suction connection is arranged in the bottom or on a base section of the circumferential edge facing the bottom.

5. The tool according to claim 1,
wherein the suction connection is in fluid connection with a plurality of suction openings arranged in the bottom or in the forming tool.

6. The tool according to claim 1,
wherein the forming tool is detachably insertable into the forming trough.

7. The tool according to claim 6,
wherein the forming tool has a base body configured to be placed on the bottom guided by at least one of the circumferential edge or by guide elements.

8. The tool according to claim 1,
further comprising a lower separating film and an upper separating film configured to overlap with the lower separating film for enclosing the preform for simplification of placing the preform on the forming tool and for prevention of a contamination.

9. The tool according to claim 1,
further comprising a placing tool with a placing area for placing the preform
wherein the placing area is smaller than an area of the bottom.

10. A method for manufacturing a thermoformed fiber composite component, comprising:
providing a preform;
placing the preform on a forming tool arranged on a bottom of a forming trough comprising a circumferential edge and a trough opening facing away from the bottom and bounded by the circumferential edge;
resting a lower boundary surface of a stenter frame supporting an elastic membrane on an upper boundary surface of the circumferential edge wherein the circumferential edge and the stenter frame are configured to form a fluid-tight connection with each other and forming an assembly,
heating the assembly to a forming temperature,
extracting air through a suction connection arranged in the forming trough so that the elastic membrane, in a direction of the bottom of the forming trough, nestles against the preform and adjacent free bottom areas, so that the preform is pressed onto the forming tool and is deformed thereby;
heating the assembly to a curing temperature and curing the formed preform to produce the component, and
removing the stenter frame with the elastic membrane and removing the component.

11. The method according to claim 10,
wherein the providing of the preform comprises at least one of placing the preform on a laying tool or cutting a prepreg to size.

12. The method according to claim 10,
wherein the preform is arranged on a lower separating film and covered by an upper separating film before being placed on the forming tool.

13. The method according to claim 10,
wherein, prior to curing the formed preform, the arrangement is arranged in an atmosphere with an increased pressure of up to 8 bar.
